(19) United States
(12) Patent Application Publication
(10) Pub. No.: US 2017/0005439 A1
(43) Pub. Date: Jan. 5, 2017

(54) ELECTRICAL CONNECTOR WITH ELECTROMAGNETIC SHIELDING AND REMOVABLE FOOLPROOFING SYSTEM

(71) Applicant: SOURIAU, VERSAILLES (FR)

(72) Inventors: PASCAL RIBEAU, LE MANS (FR); GUILLAUME SECLET, CONNERRÉ (FR)

(21) Appl. No.: 15/197,622

(22) Filed: Jun. 29, 2016

(30) Foreign Application Priority Data
Jul. 3, 2015 (FR) 15 56306

(51) Int. Cl. H01R 13/6581; H01R 43/20; H01R 13/64; H01R 13/631

(52) U.S. Cl. CPC H01R 13/6581; H01R 13/631; H01R 43/20; H01R 13/64

(57) ABSTRACT

An electrical connector with electromagnetic shielding includes a connector housing containing an insert configured to receive at least one electrical contact. The connector housing includes a connector body with a substantially cylindrical shape having a rear section, a central section and a front section. A ground ring is mounted around the front section of the connector body. A foolproofing section independent of the connector body is mounted at least partly around the front section of the connector body.

### FIELD OF THE INVENTION

The invention relates to an electrical connector with electromagnetic shielding fitted with a ground ring and a foolproofing system that can be mounted around the connector. The invention also relates to a method for mounting the connector.

The invention finds applications in all fields of connectors, particularly in the area of connectors for aeronautics.

### STATE OF THE ART

In some areas of connectors, particularly that of aeronautics connectors, the connectors are protected from the effects of electromagnetic fields in the neighborhood of said connector by shielding. Said shielding protects the internal connections of the connector from the effects of some forms of electromagnetic coupling. It protects the internal connections of the connector, particularly from radiofrequencies and electrical interference. Thus, the shielding offers the electrical connector electromagnetic immunity.

In the area of aeronautics connectors, such electromagnetic shielding is required under the standards applicable in the area. Said shielding may for instance take the form of a circular metal mesh placed between a (male or female) connector and the locking ring of a mating connector (female or male respectively) in order to ensure electrical continuity when the connectors are coupled. That metal mesh is identified by the term “ground ring”.

One exemplary embodiment in the prior art of such a connector fitted with such a ground ring is represented in FIGS. 1A and 1B. FIG. 1A represents a connector 1 fitted with a locking ring 30. FIG. 1B represents the housing 10 of the connector 1 before the locking ring 30 is installed. That connector housing 10 is substantially cylindrical in shape and comprises, in this exemplary embodiment, first, second and third cylindrical sections 13, 12, 11 with different diameters. The ground ring 20 is mounted around the connector housing 10, in a central area of said housing. More precisely, the ground ring 20 is mounted around the first section 13, between the foolproofing pins 40 of said section 13 and the second section 12 with a diameter that is larger than that of the first section 13.

Indeed, as shown in FIGS. 1A and 1B, the connector housing 10 in the prior art comprises a plurality of foolproofing pins 40, which are designed only to allow the coupling of the appropriate mating connector. In order to ensure that an inappropriate mating connector is coupled by the operator, the foolproofing pins 40 have shapes, dimensions and arrangements that are different from one connector to another. In that way, only a mating connector with a foolproofing system adapted to the foolproofing pins 40 of connector 1 is capable of being coupled with said connector 1.

In order to assemble the ground ring 20 around section 13, said ground ring must pass above the foolproofing pins 40. To do so, the ground ring 20 must be somewhat deformed. For such deformation to be possible, the ground ring 20 is generally made in an elastic metal material. That elastic metal material must, firstly, be sufficiently conductive to allow electrical continuity between the connector and the mating connector, and secondly, be sufficiently elastic to allow the ground ring to pass above the foolproofing pins 40. In view of the shape and dimensions of the foolproofing pins 40, the deformation sustained by the ground ring 20 is relatively significant, to the point that it can lead to permanent deformations of said ring. That is because if the material in which the ground ring is formed is stretched excessively, it cannot revert to its original shape. But if the ground ring 20 is permanently deformed, electrical continuity between the mating connectors is no longer provided. That is why it is necessary, after mounting the ground ring 20 around the connector housing 10, for an operator to visually verify whether the ground ring is functional. If the ground ring comprises permanent deformations and is thus not functional, then the ground ring must be removed and replaced by a new ground ring.

Thus, the mounting of the ground ring 20 around the connector housing 10 according to the prior art is delicate and costly in terms of labor (delicate operation and visual inspection) and material (the rings must be replaced if they are permanently deformed).

### DESCRIPTION OF THE INVENTION

This invention is aimed at remedying the drawbacks of the prior art. To that end, the invention relates to an electrical connector comprising electromagnetic shielding with a connector housing made of two parts: a connector body and a foolproofing section, wherein the foolproofing section is mounted on the connector body after the ground ring is installed. With such an electrical connector, the ground ring does not need to be pushed above the foolproofing pins, thus avoiding the risk of permanent deformation.

More precisely, the invention relates to an electrical connector including electromagnetic shielding, comprising a connector housing containing an insert suitable for receiving at least one electrical contact, characterized in that the connector housing comprises:
a connector body with a substantially cylindrical shape comprising a front section, a central section and a rear section,
a ground ring mounted around the front section of the connector body, and
a foolproofing section independent of the connector body and mounted at least partly around the front section of said connector body.

The foolproofing section is independent of the connector body and is mounted after the ground ring is installed; said ground ring is advantageously mounted without excessive deformation and thus with no risk of permanent deformation.

In a first embodiment, the front section comprises a circular groove formed on the perimeter of said section, and the foolproofing section is an open ring that can be fitted into the circular groove.

In accordance with that first embodiment, the foolproofing section is made in a material that can be deformed when said foolproofing section is put in place and which reverts to its initial shape after said foolproofing section has been installed in the circular groove.

In this first embodiment, the rear section comprises a groove and the foolproofing section comprises a locking element in the form of a pin that can fit in said groove. That mechanical connection prevents the foolproofing section from rotating around the connector body.

In a second embodiment, the front section comprises a grooved section and a smooth section, and the foolproofing section is a cylinder section that can be fitted around a grooved section.

Regardless of the embodiment, the foolproofing section has foolproofing pins on its perimeter.

The foolproofing pins have shapes, dimensions and arrangements that are adapted for a foolproofing system of a mating connector. The foolproofing section is independent of the connector body; as a result, many sorts of foolproofing pins may be used to comply with applicable standards.

The ground ring is made in electrically conductive material showing low deformation.

The invention also relates to a method for mounting a connector, characterized in that it comprises the following operations:
the ground ring is installed around the front section of the connector body by pushing it along said rear section up to the central section,
the foolproofing section is installed in part around the front section, so that the ground ring is placed between the central section and the foolproofing section.

### BRIEF DESCRIPTION OF FIGURES

FIGS. 1A and 1B of the prior art represent perspective views of a conventional connector with electromagnetic shielding and a conventional connector housing with electromagnetic shielding.

FIGS. 2A, 2B and 2C represent a connector with electromagnetic shielding in accordance with a first embodiment of the invention.

FIGS. 3A, 3B and 3C represent a connector with electromagnetic shielding in accordance with a second embodiment of the invention.

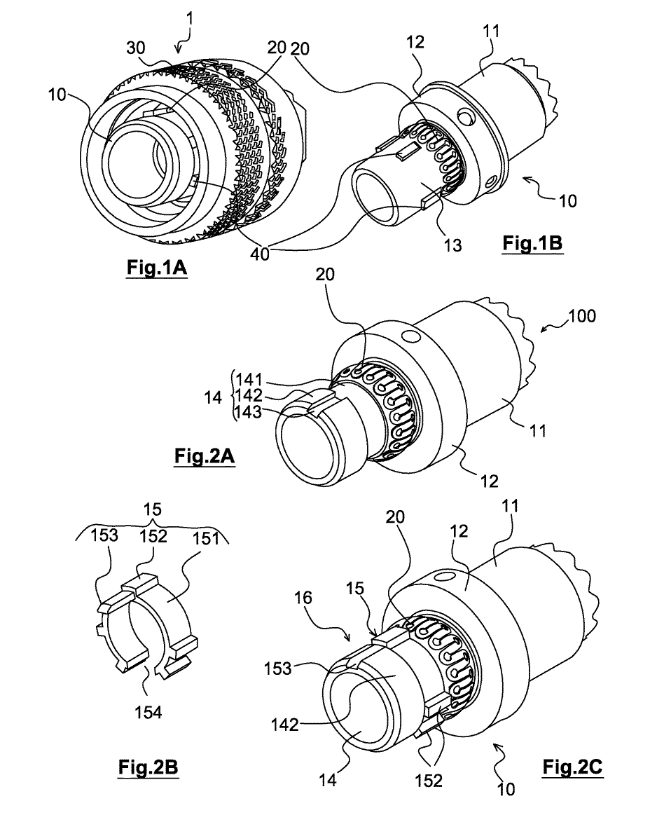

### DETAILED DESCRIPTION OF EMBODIMENTS OF THE INVENTION

In one exemplary embodiment, the connector with electromagnetic shielding according to the invention comprises a connector housing in two parts: a connector body, around which a ground ring is mounted, and a foolproofing section mounted on the connector body after the ground ring is installed.

A first embodiment of the connector housing with electromagnetic shielding according to the invention is represented in FIGS. 2A and 2C. FIG. 2A is a perspective view of a connector body 100 according to the invention. FIG. 2B is a perspective view of a foolproofing section 15 designed to be mounted on that connector body 100. FIG. 2C shows the foolproofing section 15 mounted on the connector body 100 to form a connector housing 10.

The connector body 100 is a cylindrical element suitable for receiving an insert and electrical contacts (not represented in these figures). That connector body 100 is made up of several cylindrical sections 11, 12 and 14. It comprises a rear section 11 and a central section 12 that are identical with the second and third sections 12 and 11 respectively of the prior art described earlier. It further comprises a front section 14 around which the ground ring 20 is mounted.

That rear section 14 has a diameter smaller than that of the central section 12. It further has a diameter that is not even over its length. Indeed, the front section 14 comprises a circular groove 141 on its perimeter, placed substantially at the center of said front section 14. That circular groove 141 has dimensions adapted for receiving the foolproofing section 15 representing in FIG. 2B.

The foolproofing section 15 is an open ring 151 that is equipped, on its external surface, with foolproofing pins 152. That open ring 151 is made of a material that can be deformed to allow it to be installed in the circular groove 141 of the front section 14 and to revert to its original shape after it is installed. In exemplary embodiments, said ring is made of expanded shape memory material in the martensitic state, so that when heated, it reduces in diameter during the reversion to the austenitic state or alternatively in a state known as the superelastic state. In another embodiment, said ring is made of thermoplastic polymer, which may or may not be reinforced by short fibers, which makes it cost-effective to make and offers the possibility of directly showing the color code for foolproofing. That ring 151 comprises an opening 154 with an angular dimension adapted to allow said ring to fit around the circular groove 141 while preventing the accidental removal of said ring, for example when the connector is subjected to vibrations. In an exemplary embodiment, said opening corresponds to an angular opening of about 30°.

The thickness of the open ring 151 (excluding foolproofing pins), is approximately equal to the height of the circular groove 141 of section 14. Thus, when the open ring 151 is installed in the circular groove 141, the surface of the rear area 16 of the connector body 100 is substantially uniform over its entire length. Only the foolproofing pins 152 protrude in this rear area 16.

In an exemplary embodiment, the foolproofing section 15 comprises a locking element 153 known as a pin, which protrudes from the edge of the open ring 151. That locking element 153, which is shaped like a parallelepiped, has dimensions adapted to fit in a groove 143 of the front section 14. Said groove 143 is a recess formed in the surface of the end area 142 of the front section 14, with a height approximately identical to the thickness of the locking element 153 so that when the foolproofing section 15 is installed around the front section 14, the end area 142 has a uniform surface. That locking element 153 associated with the groove 143 holds the foolproofing section 15 within the front section 14 and prevents said foolproofing section from rotating, including in the presence of vibrations.

In this embodiment, the connector with electromagnetic shielding according to the invention is manufactured as follows:
a ground ring 20 is pushed along the front section 14 from the end area 142 until it presses against the central section 12;
the foolproofing section 15 is then mounted in the circular groove 141 and made to rotate around the front section 14 until the locking element 153 fits in the groove 143.

The connector housing of the invention is thus formed. A mating connector with a foolproofing system adapted to the foolproofing pins 152 can then be coupled with the connector according to the invention.

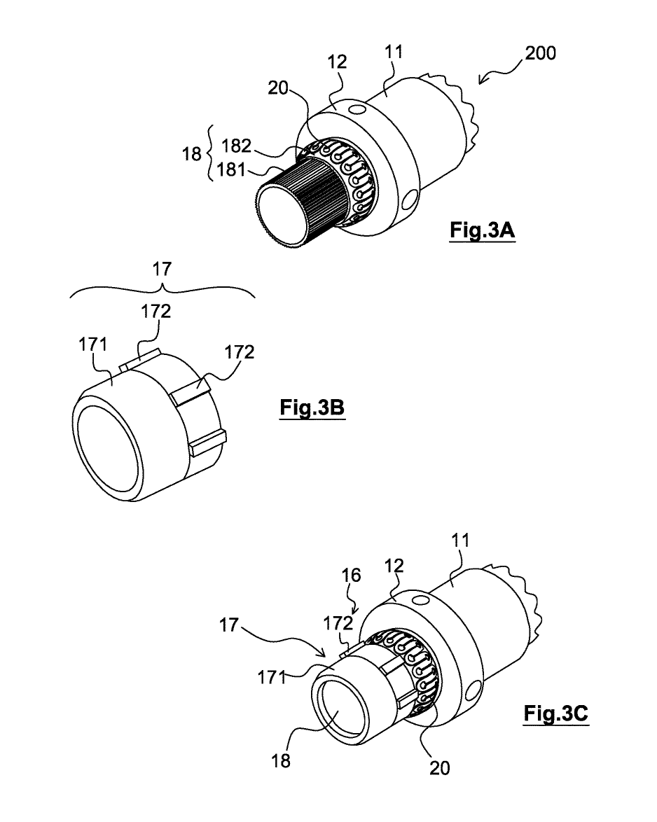

A second embodiment of the connector housing with electromagnetic shielding according to the invention is represented in FIGS. 3A and 3C. FIG. 3A is a perspective view of a connector body 200 according to the invention. FIG. 3B is a perspective view of a foolproofing section 17 designed to be mounted on the connector body 200. FIG. 3C shows the foolproofing section 17 mounted on the connector body 200 to form a connector housing 10.

The connector body 200 is a cylindrical element suitable for receiving an insert and electrical contacts (not shown in these figures). That connector body 200 comprises several cylindrical sections 11, 12 and 18. It comprises a rear section 11 and a central section 12 that are identical with the second and third sections 12 and 11 respectively of the prior art described earlier. It further comprises a front section 18 around which the ground ring 20 is mounted.

That front section 18 comprises a grooved section 181 and a smooth section 182. The smooth section 182 has a diameter larger than that of the grooved section 181 and is suitable for receiving the ground ring 20. The grooved section 181 is a cylinder with an external surface bearing a plurality of ribs parallel to each other. The grooved section 181 is designed to receive the foolproofing section 17. Those two sections 181 and 182 are manufactured in a single piece in the same material.

The foolproofing section 17 is a section of a cylinder 171 where the inner diameter is slightly larger than the outer diameter of the grooved section 181 of the front section 18. In other words, the inner diameter of the foolproofing section 17 is adapted to the outer diameter of the grooved section 181 of the front section 18 so that said foolproofing section can be fitted onto said grooved section 181. Once the foolproofing section 17 is fitted, said foolproofing section is held in position, with no risk of rotation, by the grooving of the grooved section 181.

The foolproofing section 17 comprises a plurality of foolproofing pins 172 placed on the perimeter of the cylinder section 171. As in the first embodiment, the foolproofing pins 172 may have shapes, dimensions and distributions that are different, depending on the foolproofing systems of the mating connectors.

In this second embodiment, the thickness of the cylinder section 171 is such that the outer diameter of said cylinder section is equal to the outer diameter of the smooth section 182 of the rear section 18. Thus, when the foolproofing section 17 is installed around the grooved section 181, the surface of the front area 16 of the connector body 200 is substantially uniform over its entire length. Only the foolproofing pins 172 protrude in this front area 16.

In this embodiment, the foolproofing section 17 and the connector body 200 may be made in the same material or in different materials.

In this second embodiment, the connector with electromagnetic shielding according to the invention is manufactured as follows:
a ground ring 20 is pushed along the front section 18 from the grooved section 181 up to the smooth section 182. The ground ring 20 is in position when it is around the smooth section 182 and presses against the central section 12;
the foolproofing section 17 is then force fitted around the grooved section 181 until it presses against the smooth section 182.

The connector housing of the invention is thus formed. A mating connector with a foolproofing system adapted to the foolproofing pins 172 can then be coupled with the connector according to the invention.

It can be understood from the above that regardless of the embodiment, the ground ring 20 is merely pushed along the front section 14 or 18 without a foolproofing pin hindering its installation or deforming it, as said pins are installed after the ground ring has been put in place. The ground ring 20 is made with a diameter adapted to that of the front section 14 or 18 and does not risk being deformed permanently. As a result, there is no need for particular visual inspections.

Further, regardless of the embodiment, the foolproofing section is an element independent of the connector body. Many forms of foolproofing pins with different dimensions and arrangements may thus be mounted on the connector, which makes it possible to multiply the types of connector while retaining a standard connector body. It is therefore possible to manufacture unique mechanical arrangements for all the foolproofing systems required by standards and add the selected system when the connector is installed. To make it easier to recognize the different foolproofing systems, a color code may be associated with them: each form of foolproofing system is molded in a different color, which constitutes a foolproofing key that is easily recognized by the operator.

1-9. (canceled)

10. An electrical connector with an electromagnetic shielding, comprising a connector housing containing an insert configured to receive at least one electrical contact, the connector housing comprises:
a connector body is substantially cylindrical in shape and comprises a rear section, a central section and a front section;
a ground ring mounted around the front section of the connector body; and
a foolproofing section independent of the connector body and mounted at least partly around the front section of the connector body.

11. The electrical connector according to claim 10, wherein the front section comprises a circular groove formed on a perimeter of the front section; and wherein the foolproofing section is an open ring fittable into the circular groove.

12. The electrical connector according to claim 11, wherein the foolproofing section is made of a deformable material that deforms during an installation of the foolproofing section into the circular groove and reverts to its initial shape after the installation of the foolproofing section into the circular groove.

13. The electrical connector according to claim 11, wherein the front section comprises a groove; and wherein the foolproofing section comprises a locking element or pin, that is configured to fit in the groove.

14. The electrical connector according to claim 10, wherein the front section comprises a grooved section and a smooth section; and wherein the foolproofing section is a cylinder section configured to fit around the grooved section.

15. The electrical connector according to claim 10, wherein the foolproofing section has foolproofing pins on its perimeter.

16. The electrical connector according to claim 15, wherein the foolproofing pins have shapes, dimensions and arrangements that are configured for a foolproofing system of a mating connector.

17. The electrical connector according to claim 10, wherein the ground ring is made of an electrically conductive material.

18. A method for mounting an electrical connector with an electromagnetic shielding, a connector housing of the electrical connector contains an insert configured to receive at least one electrical contact, the connector housing comprises a connector body that is substantially cylindrical in shape and comprises a rear section, a central section and a front section, the method comprising the steps of:
installing a ground ring of the connector housing around the front section of the connector body by pushing the ground ring along the front section up to the central section of the connector body; and
installing a foolproofing section, which is independent of the connector body, in part around the front section so that the ground ring is placed between the central section and the foolproofing section.
